(19) United States
(12) Patent Application Publication
(10) Pub. No.: US 2018/0247240 A1
(43) Pub. Date: Aug. 30, 2018

(54) JUDGMENT SUPPORT SYSTEM AND JUDGMENT SUPPORT METHOD

(71) Applicant: HITACHI, LTD., Tokyo (JP)

(72) Inventors: Kenzo Kurotsuchi, Tokyo (JP); Kohsuke Yanai, Tokyo (JP); Toshihiko Yanase, Tokyo (JP); Misa Sato, Tokyo (JP); Yuta Koreeda, Tokyo (JP); Yoshiki Niwa, Tokyo (JP); Kazuo Yano, Tokyo (JP)

(73) Assignee: HITACHI, LTD., Tokyo (JP)

(21) Appl. No.: 15/839,385

(22) Filed: Dec. 12, 2017

(30) Foreign Application Priority Data
Feb. 28, 2017 (JP) 2017-036311

(51) Int. Cl. G06Q 10/06; G06F 17/30

(52) U.S. Cl. CPC G06Q 10/0637; G06F 17/30716; G06F 17/30654

(57) ABSTRACT

Information appropriate for supporting various judgments in organization activities is provided. A judgment support system for supporting a user's judgment, includes: a processor that executes a program; a storage section that can be accessed by the processor; and an output section that outputs data for displaying an execution result of the program. The judgment support system further includes: an extraction section that searches a predetermined sentence expression from data stored in the storage section, and extracts an issue of an organization using text having a predetermined relationship with the searched sentence expression; and a first selection section that selects a second organization confronted with an issue similar to an issue of a first organization to be analyzed, and that selects measures against the issue of the second organization from the data stored in the storage section. The output section outputs data for displaying the selected issue and the selected measures.

### CLAIM OF PRIORITY

The present application claims priority from Japanese patent application JP 2017-036311 filed on Feb. 28, 2017, the content of which is hereby incorporated by reference into this application.

### BACKGROUND OF THE INVENTION

### 1. Field of the Invention

The present invention relates to a system for supporting various judgments in a company.

### 2. Description of the Related Art

The proportion of the number of employees engaged in the tertiary sector of the economy of the entire number of employees increased from 36% in 1955 to 67% in 2005, and the productivity growth of intellectual work is one of social challenges of today. In company activities (for example, sales, marketing, and company management), it is also required to make judgments based on a scientific basis and reasonable justification while reducing factors dependent on experience and guesswork. Furthermore, company-oriented support tools for organizing and visualizing company performance have been provided.

Moreover, the penetration of artificial intelligence (AI) into the real society has already started against a backdrop of technological advancement of the AI; the replacement of intellectual work by the AI is closer to a reality. Furthermore, with the expansion and enhancement of the use of the Internet, a large amount of digitized information useful for company management have been provided.

The following conventional techniques are known as background art of the present technical field. JP-2007-310851-A discloses a business support system characterized in that patterns in which items occur and desirable activity procedures for each pattern are established as assumptions, and a search engine for detecting occurrences of item occurrence cases in the assumptions from movements of transaction history data, company data, and other customer data, notifies a sales personnel of contents of the item occurrence cases and proposal procedures.

In addition, JP-2015-215811-A discloses a purpose-or-factor extraction device, in which a search section acquires a document group in which an action input from a Web document database (DB) is described. A candidate extraction section extracts a candidate of an action purpose or one of a factor and a reason of the input action on the basis of a clue expression held in a clue expression DB, from the document group acquired by the search section by dependency parsing. A purpose-or-factor extraction section determines the candidate as the factor or reason when a tense of the candidate is a past form. In addition, the purpose-or-factor extraction section extracts the action purpose or one of the factor and the reason from a candidate part in accordance with a result of comparing a use example of the candidate or a use example of coupling a paraphrastic expression of a use of the action purpose to the candidate with a use example of coupling a paraphrastic expression of a use of the factor or reason to the candidate.

### SUMMARY OF THE INVENTION

Since the business support system described in JP-2007-310851-A mentioned above is unable to present a reasonable basis for a proposal to a customer or other measures against the same issue, it is difficult for personnel to judge whether to adopt measures proposed by the AI.

In addition, the purpose-or-factor extraction device described in JP-2015-215811-A is unable to extract an action purpose that a user potentially has and it is difficult for the device to propose an action to an unknown action purpose since the user needs to designate the action purpose.

Furthermore, it is desired to briefly provide truly useful information for company management since it is difficult for personnel to read a large amount of information provided on the Internet and sort out useful information.

Owing to this, demand for providing measures that become a next move of a customer without inputting an issue is growing. In addition, the customer does not always recognize measures to be taken by the customer. It is considered to rather accept an order from the customer by proposing measures which the customer is unaware of but which the customer needs to take. Owing to this, demand for a system to provide sales personnel with measures which the customer should take and the customer is unaware of is growing.

A typical example of the invention disclosed in the present application is as follows. That is, a judgment support system for supporting a user's judgment, includes: a processor that executes a program; a storage section that can be accessed by the processor; and an output section that outputs data for displaying an execution result of the program. The judgment support system further includes: an extraction section that searches a predetermined sentence expression from data stored in the storage section, and that extracts an issue of an organization using text having a predetermined relationship with the searched sentence expression; and a first selection section that selects a second organization confronted with an issue similar to an issue of a first organization to be analyzed, and that selects measures against the issue of the second organization from the data stored in the storage section. The output section outputs data for displaying the selected issue and the selected measures.

According to an aspect of the present invention, it is possible to provide appropriate information for supporting various judgments in company activities. Objects, configurations, and effects other than those mentioned above will be readily apparent from the description of an embodiment given below.

### BRIEF DESCRIPTION OF THE DRAWINGS

FIG. 1 is a diagram illustrating a configuration of a judgment support system according to an embodiment of the present invention;

FIG. 2 is a chart illustrating an example of a configuration of performance/financial data according to the present embodiment;

FIG. 3 is a chart illustrating an example of a configuration of target company data according to the present embodiment;

FIG. 4 is a chart illustrating an example of a configuration of company attribute integrated data according to the present embodiment;

FIG. 5 is a chart illustrating an example of a configuration of issue/measures data according to the present embodiment;

FIG. 6 is a chart illustrating an example of a configuration of sales/introduction example data according to the present embodiment;

FIG. 7 is a flowchart of processes executed by a customer access support section according to the present embodiment;

FIG. 8 is an explanatory diagram of processes executed by a qualitative data extraction section according to the present embodiment;

FIG. 9 is an explanatory diagram of processes executed by the judgment support system according to the present embodiment; and

FIG. 10 is a diagram illustrating a screen for customer access support information output by the judgment support system according to the present embodiment.

### DESCRIPTION OF THE PREFERRED EMBODIMENTS

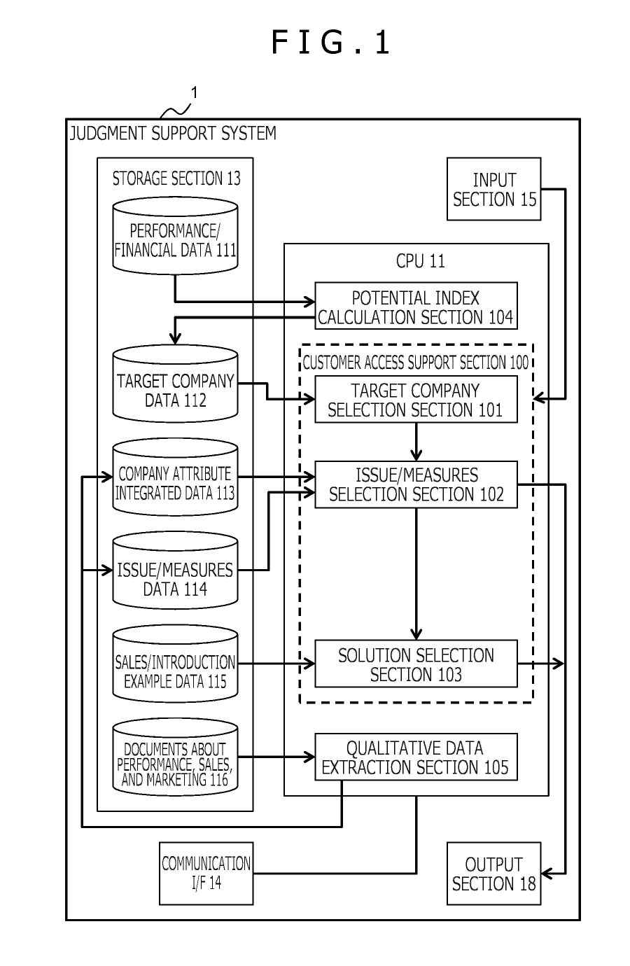

FIG. 1 is a diagram illustrating a configuration of a judgment support system 1 according to an embodiment of the present invention.

As will be described later, the judgment support system 1 according to the present embodiment provides management issues and measures, potential needs, and measures against the issues and the needs of each company. The judgment support system is used by a sales division to cultivate commodities to be provided to customers, or used by management for managerial judgments of an own company and analysis of other industry peers. While an example of applying the present judgment support system 1 to companies will be described in the following embodiment, the judgment support system 1 is also applicable to divisions in companies or various groups present in a society.

The judgment support system 1 according to the present embodiment is configured with a computing system that includes a processor (CPU) 11, a storage section 13, a communication interface 14, an input section 15, and an output section 18.

The processor 11 executes programs (for example, a customer access support program, a potential index calculation program, and a qualitative data extraction program) stored in a memory (not shown). The memory includes a read only memory (ROM) that is a nonvolatile memory element and a random access memory (RAM) that is a volatile memory element. The ROM stores an immutable program (for example, basic input/output system (BIOS)) and the like. The RAM: is a fast volatile memory element such as a dynamic random access memory (DRAM), and temporarily stores the programs executed by the processor 11 and data that is used during execution of the programs. Specifically, by causing the processor 11 to execute the various programs, a customer access support section 100, a potential index calculation section 104, and a qualitative data extraction section 105 function. The customer access support section 100 includes a target company selection section 101, an issue/measures selection section 102, and a solution selection section 103.

The target company selection section 101 selects target companies from a target business category input by a user. The issue/measures selection section 102 performs an analogy between the companies and selects a potential issue of each target company and measures against the potential issue. The solution selection section 103 has a potential need selection function that performs issue matching to select a potential need of each target company, and a commodity selection function that selects a product or a service to be introduced. The potential index calculation section 104 creates target company data 112 from performance/financial data 111. The qualitative data extraction section 105 creates company attribute integrated data 113 and issue/measures data 114 from documents about performance, sales, and marketing 116. It is noted that the potential need is a concept that contains both an issue which each company is potentially confronted with and measures which should be potentially taken by the company.

The storage section 13 is a mass-storage and nonvolatile memory device that is, for example, a magnetic memory device (hard disk drive (HDD)) or a flash memory (solid state drive(SSD)). The storage section 13 stores data accessed at a time of executing each program. The storage section 13 may store the programs executed by the processor 11. In this case, each program is read out from the storage section 13, loaded into the memory, and executed by the processor 11. Specifically, the storage section 13 stores the performance/financial data 111, the target company data 112, the company attribute integrated data 113, the issue/measures data 114, the sales/introduction example data 115, and the documents about performance, sales, and marketing 116.

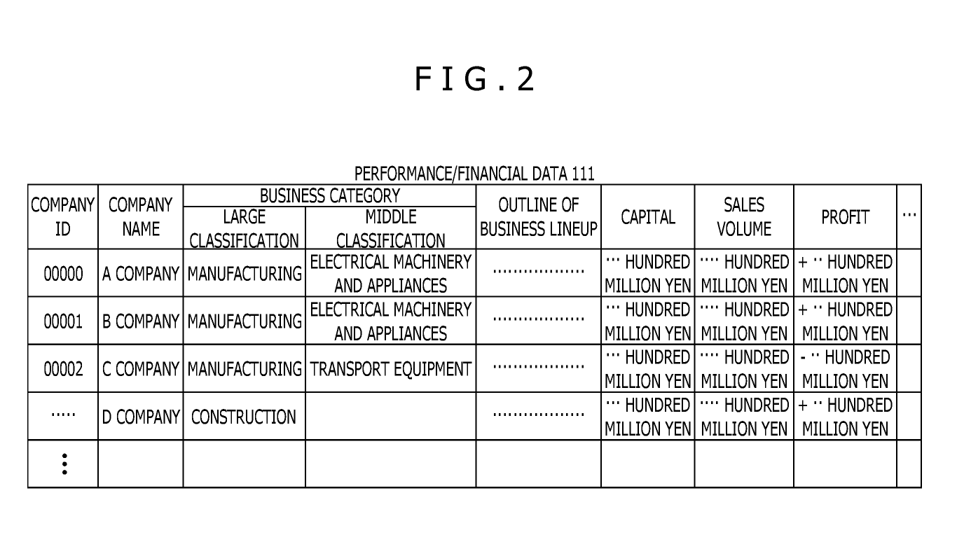

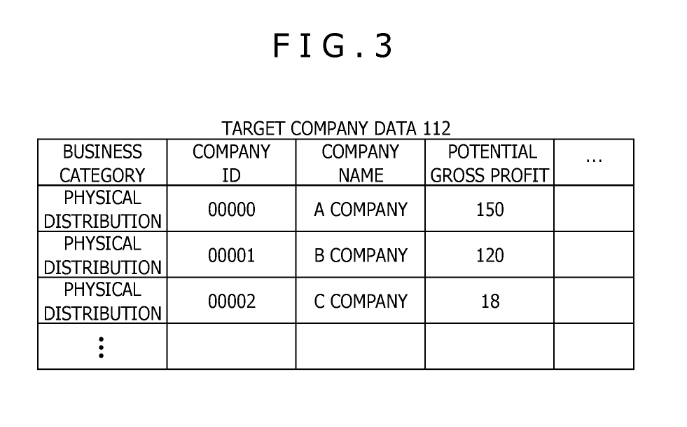

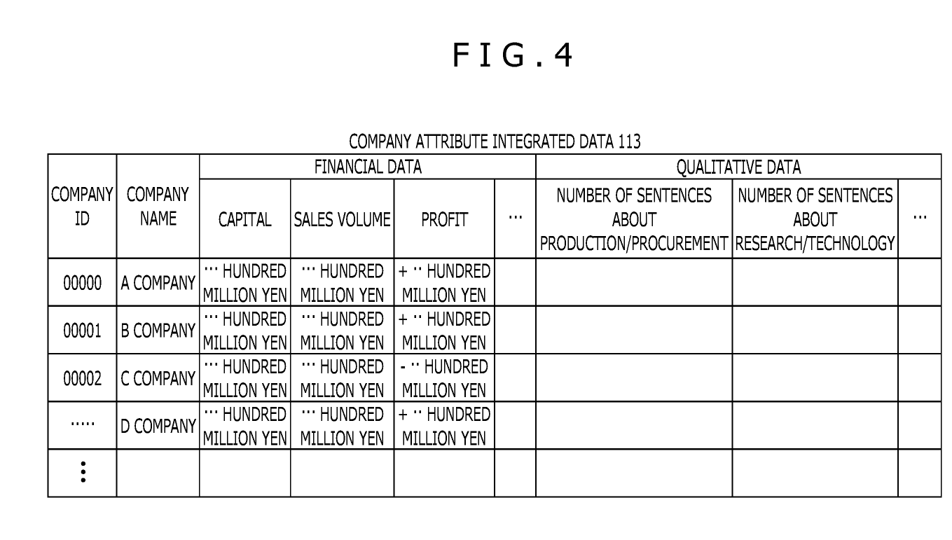

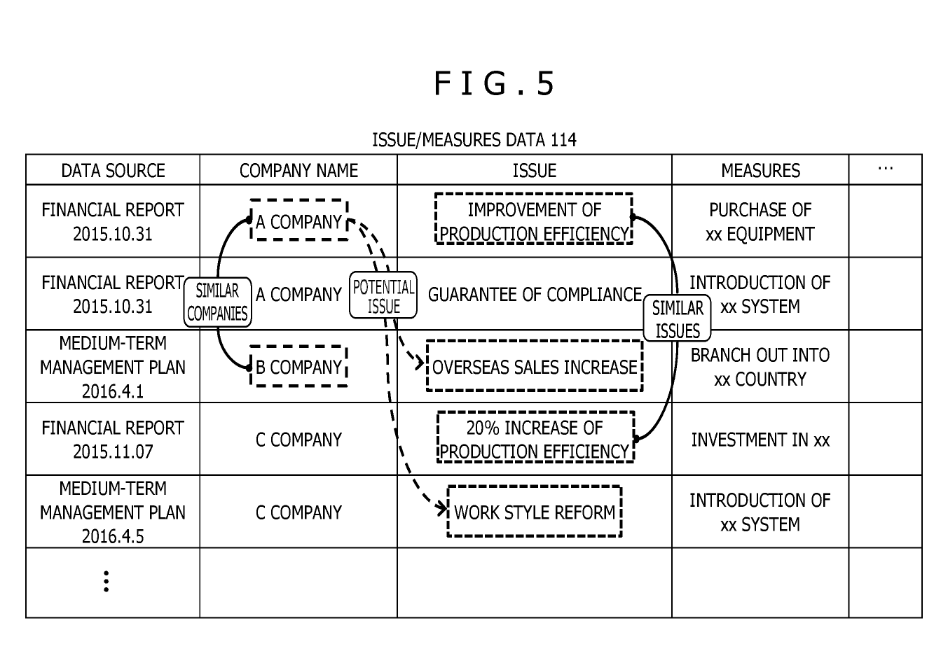

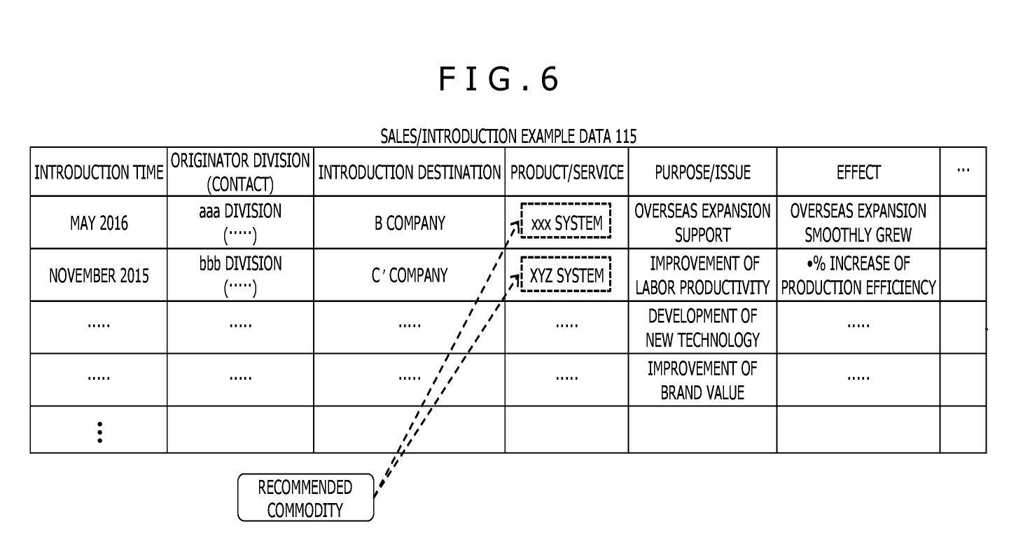

The performance/financial data 111 is a database that records performance and financial data on each company and will be described in detail with reference to FIG. 2. The target company data 112 is a database that records data on each company targeted by the judgment support system 1 and will be described in detail with reference to FIG. 3. The company attribute integrated data 113 is a database that records attributes of each company and will be described in detail with reference to FIG. 4. The issue/measures data 114 is a database that records issues which each company is confronted with and will be described in detail with reference to FIG. 5. The sales/introduction example data 115 is a database that records data on a product and/or a service introduced by each company and will be described in detail with reference to FIG. 6.

The documents about performance, sales, and marketing 116 are documents on which activity situations of each company are described, and stored in the storage section 13 in a form (for example, text data) that can be subjected to full-text searching. The documents about performance, sales, and marketing 116 include, for example, information (financial information such as financial reports) that can be acquired from EDINET, news release of each company, information on a website of each company, papers, a president's message, non-financial information (for example, social, environment, and governance information), articles of newspapers and magazines (such as economic newspapers, industrial newspapers, trade papers, general newspapers, local newspapers, and technical journals), and information on various websites (such as information posted on news websites and curation websites, and information from social networking service (SNS)).

The configurations of the other data will be described later with reference to FIGS. 2 to 6.

The communication interface 14 is a network interface device that controls communication with other apparatuses in accordance with a predetermined protocol. For example, the data stored in the storage section 13 may be input to the judgment support system 1 via the communication interface 14.

The input section 15 is an interface to which a keyboard, a mouse, and the like are connected and which receives input from an operator. The output section 18 is an interface to which a display apparatus, a printer, and the like are connected and to which the operator outputs an execution result of each program in a visible form.

The programs executed by the processor 11 are each provided to the judgment support system 1 via a removable media (such as a CD-ROM or a flash memory) or a network, and stored in the nonvolatile storage section 13 that is a non-transitory storage medium. Owing to this, the judgment support system 1 may includes an interface for reading data from the removable media.

The judgment support system 1 is the computing system configured physically on one computer or configured on a plurality of computers configured either logically or physically, and may operate on a virtual computer configured on a plurality of physical computer resources.

FIG. 2 is a chart illustrating an example of a configuration of the performance/financial data 111 according to the present embodiment.

The performance/financial data 111 records performance and financial data on each company, and includes data such as a company ID, a company name, a business category (large classification and middle classification), an outline of a business lineup, a capital, a sales volume, and a profit. The performance/financial data 111 can be acquired from financial reports if the company is a publicly-quoted company. The data included in the performance/financial data 111 include not only data shown in FIG. 2 but also data that directly affects management (such as sales volumes, current profits, asset turnovers, and cash conversion cycles of last three years), data that does not directly affect the management but possibly indirectly affects the management (such as genders, alma maters, and native places of a business manager and company officials, and the number of employees), data about activities of sales, taking of orders, and purchases from each company to other companies (such as an order volume, a gross profit, a sales amount, delivery periods, delivery destination companies, and item names). It is defined herein that a company to which sales personnel to be supported by the judgment support system 1 belongs is the “own company” and that companies that are customers of the sales personnel are “customer companies.”

FIG. 3 is a chart illustrating an example of a configuration of the target company data 112 according to the present embodiment.

The target company data 112 records data on each company targeted by the judgment support system 1, is created by the potential index calculation section 104 from the performance/financial data 111, and is used for the target company selection section 101 to select companies targeted by the judgment support system 1 from the business category input by a user. The target company data 112 includes data such as the business category, the company ID, the company name, and a potential gross profit. The potential gross profit is a gross profit for products sold to or services provided to customers and serves as an index of a profit expected in dealing with the customer companies. While including the potential gross profit, the target company data 112 shown in FIG. 3 may include another index used for ranking the target companies.

Items included in the target company data 112 may dynamically vary depending on the index for ranking the target company candidates. For example, when a target index for determining an order of displaying the target companies is designated, the potential index calculation section 104 adds data found to have a correlation with the target index to the target company data 112. The target company selection section 101 refers to the target company data 112 from a viewpoint of the data found to have the correlation with the target index, and determines the order of displaying the target company candidates. By using a result obtained as described above, it is possible to make a list of the companies in an order based on the desired target index.

FIG. 4 is a chart illustrating an example of a configuration of the company attribute integrated data 113 according to the present embodiment.

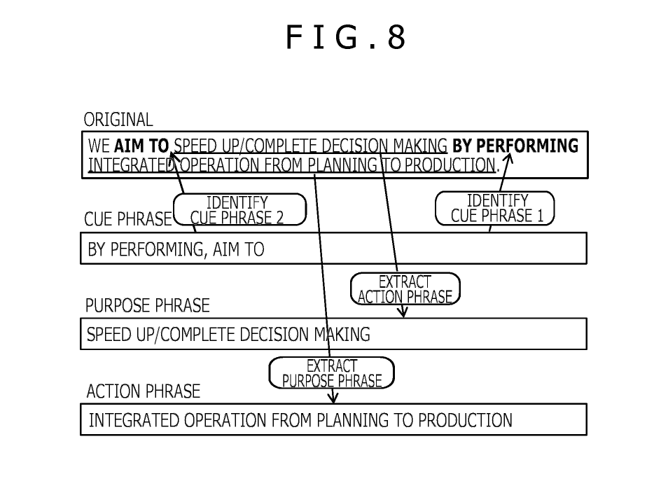

The company attribute integrated data 113 records company attributes, is created by the qualitative data extraction section 105 from the documents about performance, sales, and marketing 116, and is used for the issue/measures selection section 102 to select similar companies, that is, to perform an analogy between the companies. The company attribute integrated data 113 includes financial data, qualitative data, and the like. The financial data is the capital, the sales volume, the profit, and the like, and can be acquired from financial statements (for example, financial reports) that are the documents about performance, sales, and marketing 116. The qualitative data indicates an amount of information related to specific matters that are, for example, the number of sentences about production and procurement in the documents about performance, sales, and marketing 116 and the number of sentences about research and technology in the documents about performance, sales, and marketing 116. The qualitative data can be used as an index that indicates a feature of each company, a field to which the company is committed, and a value on which the company places emphasis depending on each item of interest. Processes by the qualitative data extraction section 105 for creating the company attribute integrated data 113 from the documents about performance, sales, and marketing 116 will be described later with reference to FIG. 8.

FIG. 5 is a chart illustrating an example of a configuration of the issue/measures data 114 according to the present embodiment.

The issue/measures data 114 records an issue with which each company is confronted, is created by the qualitative data extraction section 105 from the documents about performance, sales, and marketing 116, and is used for the issue/measures selection section 102 to select measures against the issue or select a potential issue. The issue/measures data 114 includes data such as data sources, company names, and issues and measures. Each data source is information (such as a document name and an issuance date) for identifying a source document from which the issue and the measures are extracted. Each issue is a management issue with which each company is confronted, and the measures are those adopted or planned to be adopted against the issue.

If being classified by managerial values, the issue/measures data 114 is preferable since the user can easily read data presented by the system. Specifically, it is preferable to classify the issue/measures data 114 on companies by managerial values using a managerial value system dictionary (not shown). The managerial value system dictionary is a list of words (such as “compliance” and “active female participation”) representing managerial values and arranged by the managerial values such as organizing power and business/sales. For example, the “compliance” and the “active female participation” are classified to belong to the “organizing power” as the managerial value and words representing regions such as “Asia” are classified to belong to “business/sales” as the managerial value. Specifically, when a management issue sentence is “guarantee of compliance,” this sentence includes a managerial value word “compliance” that belongs to the “organizing power.” Therefore, this management issue sentence is classified into the “organizing power.” In other words, this management issue sentence (meaning of a real world) can be grounded to a symbol of the “organizing power.” That is, it is possible to deal with a symbol grounding problem in natural language processing. Classifying enables the following. First, it is possible to intensively read only a class interesting the user. Second, it is possible to comprehensively grasp the management issues of the companies by user's reading top-ranking management issue sentences in all classes.

Next, operations performed by the present system will be described. The present system selects an issue of a company to which the sales personnel pays a visit, thereby searching issues of other companies similar to the selected issue and presenting measures against the similar issues to the sales personnel.

It is noted that taking measures is also a new issue. Owing to this, the measures can be rephrased as a new issue deriving from subdividing (breaking down) of an original issue. That is, it is possible to subdivide each issue using the present system.

FIG. 6 is a chart illustrating an example of a configuration of the sales/introduction example data 115 according to the present embodiment.

The sales/introduction example data 115 is data on a product/service introduced by each company, is created by arranging data on sales activity, order taking activities, and purchase activities from the viewpoint of sales/introduction, and is used for the solution selection section 103 to select a product and/or a service suitable to be introduced into the company. The sales/introduction example data 115 includes data such as introduction time, an originator division, an introduction destination, a product/service, a purpose/issue, and an effect. The introduction time is time at which the company introduced the product or service. The originator division is a division in charge of selling the product or service. The introduction destination is a company that purchased the product or service. The product/service is a name of the introduced product or service. The purpose/issue is a purpose or an issue for which the company introduced the product or the service. The effect is an effect generated or expected to be generated by the product or service.

The sales/introduction example data 115 may include not only data on the own company but also data on products or services which other companies sold to companies. In this case, the sales/introduction example data 115 may be created by collecting information on websites of the other companies related to introduction examples. Further, the originator division is a company that sold the product or service.

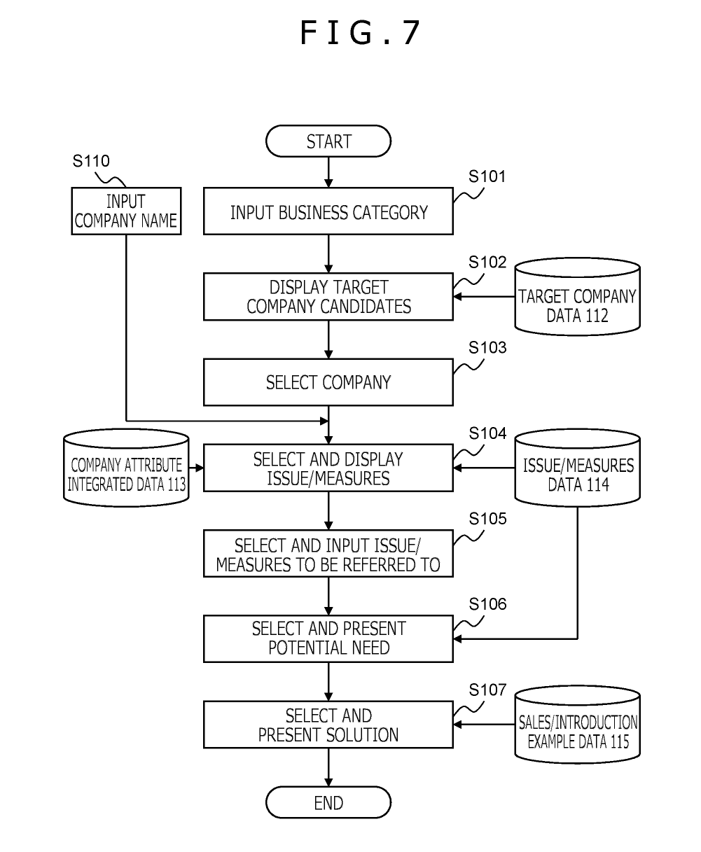

FIG. 7 is a flowchart of processes executed by the customer access support section 100 according to the present embodiment.

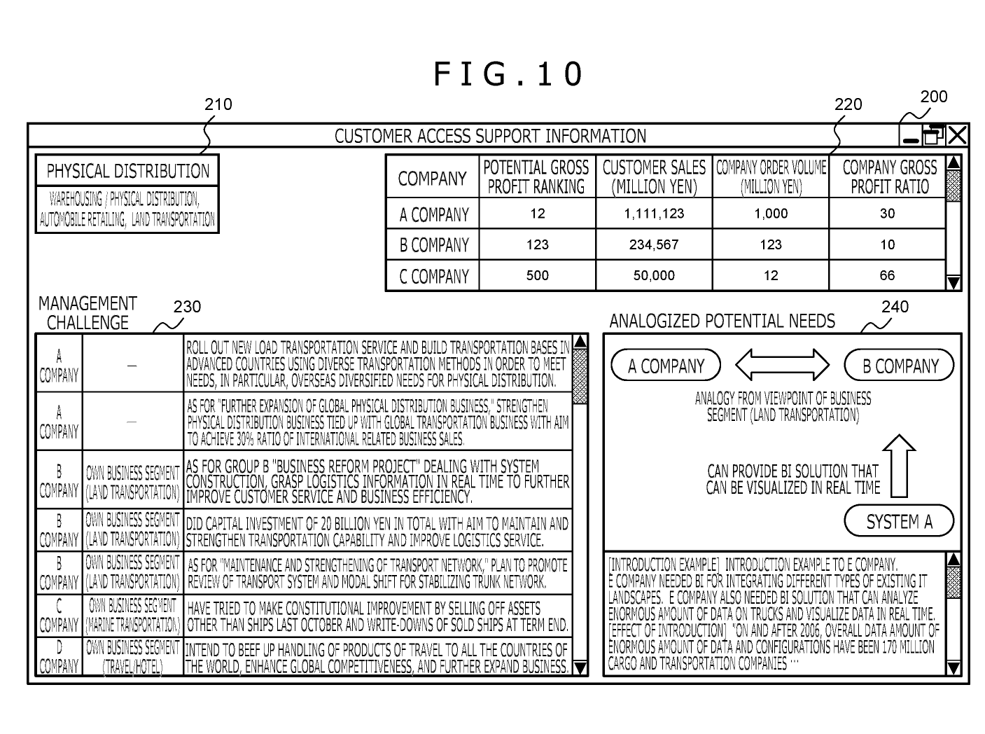

First, when a target business category which the user desires to analyze is input to the input section 15, the target company selection section 101 receives the input target business category (S101), refers to the target company data 112, and selects companies belonging to the input target business category as target company candidates. The target company selection section 101 arranges the selected companies in a predetermined order and displays the selected companies in a company list display region 220 (see FIG. 10) on the customer access support information screen 200 (S102). It is preferable that the order of displaying the companies in the company list display region 220 is a descending order of the index (for example, the potential gross profit) contributing to improving the management index of the own company. It is preferable that the user can designate the order of displaying the companies. When the user designates the target index, the order of displaying the companies is controlled in accordance with the correlation found by the potential index calculation section 104.

The user then selects a company to be analyzed from the company list display region 220. The target company selection section 101 passes a company ID of the selected target company to the issue/measures selection section 102 (S103). It is noted that the target company selection section 101 may receive not the input business category but an input company name. In this case, the target company selection section 101 checks the input company name in the target company data 112. The target company selection section 101 determines the company as the target company and passes the company ID to the issue/measures selection section 102 when the input company name is registered in the target company data 112 (S110).

Next, the issue/measures selection section 102 selects measures against an issue of the target company while referring to the issue/measures data 114 (S104). Specifically, the issue/measures selection section 102 searches an issue of the other company similar to the issue of the target company from the issue/measures data 114, and determines measures corresponding to the searched issue as the measures of the target company. A reason of determination is that the measures against the similar issues are common and there is a probability that the issue of the target company can be solved by measures for other companies.

Furthermore, the issue/measures selection section 102 performs an analogy between the companies, and selects an issue and measures of the company analogized from the target company as a potential issue of the target company and measures against the potential issue (S104). Even if the issue of the target company is unknown or unclear, in particular, it is possible to discover the potential issue of the target company by the analogy between the companies.

Specifically, the issue/measures selection section 102 selects a company similar to the target company in attributes while referring to the company attribute integrated data 113, and determines the potential issue that is the issue of the selected company and the measures corresponding to the selected issue as an issue/measures pair of the target company. A reason of determination is that the companies similar in attributes are confronted with a common issue and the issue is the possible issue of the target company. For example, in FIG. 5, if A company and B company are similar in company attributes, then it is estimated that the A company and the B company have a common issue, the issue (overseas sales increase) of the B company is also the potential issue of the A company, and “branch out into xx country” is possible measures of the A company. In this way, the present system not only presents “improvement of production efficiency” and “guarantee of compliance” that are the overt issues of the A company and “purchase of xx equipment” that is overt measures thereof to the sales personnel but also presents the potential issue and the potential measures of the A company to the sales personnel.

That is, the issue/measures selection section 102 selects an item to which the companies pay attention (for example, a criterion common to the similar companies from the viewpoint of the sales personnel), and selects a company group closer in the selected criterion. For example, the issue/measures selection section 102 selects companies closer to the target company (A company) in the sales volume. When there is a product that can be sold to the companies having the closer sales volume among products for which there is a track record of selling to the selected companies, the product can be determined as a product that can solve the issue of the A company and that is likely to be sold to the A company. Viewpoints of the analogy include the sales volume, a business industry, a management issue, and the like.

The issue/measures selection section 102 then displays the selected issue of the target company and the measures that can be taken to solve the issue in a management issue display region 230 (see FIG. 10) on the customer access support information screen 200. At this time, it is preferable to display the issue/measures pair by the number of characters to an appropriate extent for the user (for example, sales personnel) to read the pair. While the issue/measures selection section 102 may display all issue/measures pairs, the issue/measures selection section 102 may rank the issues and display the issue/measures pairs by the number that is a predetermined number of higher-ranking issues, that is, the number to an appropriate extent for the user to read the pairs.

In another alternative, the user may judge whether the issue/measures pairs displayed in the management issue display region 230 are good or bad, so that feedback can be input to the present system. For example, an evaluation input box may be provided per issue in the management issue display region 230, and a value obtained by statistically processing an input evaluation (for example, an average value) may be recorded in the issue/measures data 114, thereby controlling ranking of the order of display.

Subsequently, when the user selects an issue and measures to be referred to in the management issue display region 230, the solution selection section 103 receives input of the selected issue and measures (S105).

The solution selection section 103 refers to the issue/measures data 114, performs issue matching, selects a company confronted with a similar issue to the issue of the target company, selects the issue of the selected company from the issue/measures data 114, and determines the selected issues as a potential need of the target company (S106). A reason of determination is that the companies similar in the issues are possibly confronted with another common issue and the common issue is the possible potential need of the target company.

Generally, an issue is expressed as a purpose phrase. Therefore, it is possible to select the company confronted with the similar issue by determining a similarity between object phrases and selecting an object phrase having a high similarity. To determine the similarity between the purpose phrases, N-gram indexing (N-gram) can be used. Further, issues (purpose phrases) may be searched for companies in an industry to which the target company belongs. For example, in FIG. 5, the issue (improvement of production efficiency) of the A company is similar to the issue (20% increase of production efficiency) of C company. Therefore, the A company and the C company are similar in the company attributes and an issue (work style reform) of the C company is the possible potential need (potential issue) of the A company. The solution selection section 103 displays the potential issue of the target company and measures that can be taken to solve the potential issue in a potential need display region 240 (see FIG. 10) on the customer access support information screen 200.

Furthermore, the solution selection section 103 may provide an action phrase corresponding to the purpose phrase obtained by the issue matching as other measures that can be taken by the target company. That is, the action phrase included in another management issue sentence that includes the similar purpose phrase is a possible action that is an action of the other company against the similar issue and that is an action which is not taken yet by and necessary for the target company. The user can judge whether the analyzed action is suited for the target company and include the action in a proposal to the target company.

Furthermore, the solution selection section 103 refers to the sales/introduction example data 115, selects a product or service to be introduced for solving the potential need (issue), and displays the product or service to be introduced as measures that can taken by the A company for solving the issue as a recommended commodity candidate in the potential need display region 240 (see FIG. 10) (S107).

FIG. 8 is an explanatory diagram of processes executed by the qualitative data extraction section 105 according to the present embodiment.

As described above, the qualitative data extraction section 105 creates the company attribute integrated data 113 and the issue/measures data 114 from the documents about performance, sales, and marketing 116. The qualitative data extraction section 105 may search text extracted from the documents about performance, sales, and marketing 116 using AI (Artificial intelligence) technology.

For example, the qualitative data extraction section 105 extracts a purpose phrase and an action phrase using preset clue phrases. The clue phrases are phrases enabling a grammar to be analyzed with the clue phrases as a key, so that the qualitative data extraction section 105 extracts words used to have specific meanings on the basis of position relationships in a sentence with the clue phrases. That is, the phrases placed in predetermined position relationships with the clue phrases (for example, in front of or in rear of the clue phrases) are used while the phrases have specific meanings (for example, for a purpose, an action, and/or the like). Furthermore, the qualitative data extraction section 105 searches the purpose phrase and the action phrase in accordance with a preset extraction rule. In the example shown in FIG. 8, two phrases “by performing” and “aim to” are designated as the clue phrases, and the qualitative data extraction section 105 extracts a phrase in rear of “by performing” as the action phrase and a phrase in rear of “aim to” as the purpose phrase. Using the clue phrases and the extraction rule, the qualitative data extraction section 105 can extract the purpose phrase and the action phrase corresponding to the purpose phrase. The extracted purpose phrase and the extracted action phrase are the issue of each company and the measures against the issue, respectively. Needless to say, it is possible to extract the object phrase and the action phrase using not the method of using the clue phrases but machine learning or deep learning.

Operations performed by the qualitative data extraction section 105 will be described specifically while referring to the example shown in FIG. 8. The qualitative data extraction section 105 extracts a sentence including both “by performing” and “aim to” as the management issue sentence from the documents about performance, sales, and marketing 116. Next, the qualitative data extraction section 105 applies the extraction rule to the management issue sentence, extracts “speed up/complete decision making” as the purpose phrase, and extracts “integrated operation from planning to production” as the action phrase corresponding to the purpose phrase. The extracted purpose phrase is the issue and the extracted action phrase is the measures, and the purpose phrase and the action phrase are recorded in the issue/measures data 114 as an issue/measures pair.

It is noted that the clue phrases and the extraction rule are given as an example and the qualitative data extraction section 105 may use a combination of other clue phrases and another extraction rule. For example, the Artificial Intelligence may learn a purpose phrase and an action phrase to be extracted using supervisory data as an alternative to the preset clue phrases, and may extract the purpose phrase and the action phrase.

Furthermore, the issue/measures pair of the company may be input from another system. For example, the issue/measures pair input by the user using a system which is not shown may be recorded in the issue/measures data 114.

Moreover, the qualitative data extraction section 105 may extract the issue from the performance/financial data 111. For example, when the sales volumes decreased for three consecutive years, the qualitative data extraction section 105 registers “recent decrease of sales volumes” in the issue/measures data 114 as the issue.

Furthermore, the qualitative data extraction section 105 creates the company attribute integrated data 113 from the documents about performance, sales, and marketing 116. Specifically, the qualitative data extraction section 105 refers to a predetermined word dictionary (not shown), counts the number of sentences each of which includes a predetermined number or more of words related to production and procurement, and records the number in the company attribute integrated data 113. Similarly, the qualitative data extraction section 105 counts the number of sentences each of which includes words related to research and technology and records the number in the company attribute integrated data 113.

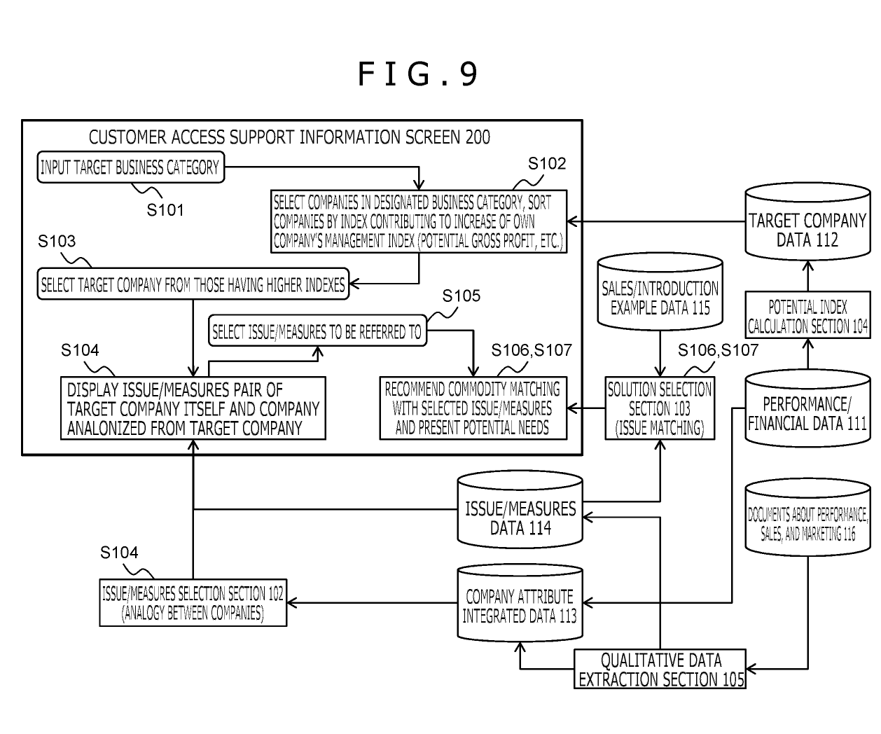

FIG. 9 is an explanatory diagram of processes executed by the judgment support system 1 according to the present embodiment.

The judgment support system 1 according to the present embodiment operates on the customer access support information screen 200.

First, when the target business category which the user desires to analyze is input to the customer access support information screen 200 (S101), the target company selection section 101 refers to the target company data 112, selects the companies belonging to the target business category, arranges the selected companies in the predetermined order (in the descending order of the index (for example, the potential gross profit) contributing to improving the management index of the own company), and displays the selected companies in the company list display region 220 (S102).

The user then selects the company to be analyzed from those having higher indexes in the company list display region 220 (S103), and the issue/measures selection section 102 refers to the issue/measures data 114 and selects the measures against the issue of the target company. Furthermore, the issue/measures selection section 102 performs an analogy between the companies, selects the issue and the measures of the company analogized from the target company as the potential issue of the target company and the measures against the potential issue, and displays the potential issue and the potential measures of the target company in the management issue display region 230 (S104).

Subsequently, when the user selects the issue and the measures to be referred to in the management issue display region 230 (S105), the solution selection section 103 refers to the issue/measures data 114, performs the issue matching, selects the potential need of the target company, and displays the selected potential need in the potential need display region 240 (S106).

Moreover, the solution selection section 103 refers to the sales/introduction example data 115, selects the product or service to be introduced for solving the potential issue (S107), and displays the selected product or service in the potential need display region 240.

The potential index calculation section 104 finds data correlated with the target index from the performance/financial data 111, and creates the target company data 112. For example, when the gross profit is designated as the target index, the potential index calculation section 104 calculates correlativity between various data included in the performance/financial data 111 and the gross profit. The potential index calculation section 104 can mechanically execute correlativity calculation using a support vector machine or the like. The potential index calculation section 104 finds data having high correlativity from an obtained result. For example, when the gross profit is designated as the target index and a result indicating that there is a correlation between the gross profit and the number of employees is obtained, the potential index calculation section 104 outputs an indication that the data correlated with the target index (gross profit) is the number of employees, and records the number of employees in the target company data 112.

The qualitative data extraction section 105 creates the company attribute integrated data 113 and the issue/measures data 114 from the documents about performance, sales, and marketing 116 using, for example, a method shown in FIG. 8.

FIG. 10 is a diagram illustrating the screen 200 for the customer access support information output by the judgment support system 1 according to the present embodiment.

The customer access support information screen 200 includes a business category display region 210, the company list display region 220, the management issue display region 230, and the potential need display region 240.

The business category input by the user (or company business category input by the user) is displayed in the business category display region 210. The companies belonging to the business category input by the user (target company candidates) arranged in the predetermined order are displayed in the company list display region 220. The user can select the target company to be analyzed from the companies displayed in the company list display region 220. As described above, it is preferable that the order of displaying the companies in the company list display region 220 is the descending order of the index (for example, the potential gross profit) contributing to improving the management index of the own company.

The issue of the target company and the measures that can be taken to solve the issue are displayed in the management issue display region 230. In this case, the issues can be ranked and a predetermined number of higher-ranking issues may be displayed. The user can select the issue to be analyzed from the issues displayed in the management issue display region 230.

The analyzed issue (potential need) of the target companies and the product or service (that is, the recommended commodity candidate) to be introduced as the measures for solving the potential need are displayed in the potential need display region 240. It is preferable to display, for example, not only a name of the system but also introduction examples of the other companies and the effect of introduction of the system as well as recommended commodities.

As described so far, according to the embodiment of the present invention, the judgment support system 1 includes: the qualitative data extraction section 105 that searches a predetermined sentence expression from the documents about performance, sales, and marketing 116, and that extracts an issue of an organization (a company, a division in the organization, or various groups) using text having a predetermined relationship with the searched sentence expression; and the solution selection section 103 that selects a second organization confronted with an issue similar to an issue of a first organization to be analyzed, and that selects measures against the issue of the second organization from the issue/measures data 114. Therefore, it is possible to provide appropriate information for supporting organization activities. It is possible, in particular, to grasp the potential need and the measures of the target organization without inputting an issue.

Furthermore, the predetermined sentence expression is a phrase (clue phrase) that enables a grammar to be analyzed with the sentence expression as a key, and the qualitative data extraction section 105 extracts a word at a position having the predetermined relationship with the searched sentence expression (for example, in front of or in rear of the searched sentence expression) as the issue. Therefore, it is possible to accurately extract issues of the organization from various sentences.

Moreover, the predetermined sentence expression is a phrase that represents an issue determined using supervisory data, and the qualitative data extraction section 105 extracts the searched sentence expression as text having the predetermined relationship and designates the text as the issue. Therefore, it is possible to accurately extract issues of the organization from various sentences. It is noted that the sentence expression created by personnel manual work can be used as the supervisory data. It is also possible to mechanically search many documents and statistically collect characteristic sentence expressions. Needless to say, means for searching the issue is not limited to means for using the sentence expression. For example, it is possible to statistically estimate a word or a phrase that is highly likely to become an issue while utilizing correct answer data already known as an issue by using machine learning such as statistical processing or deep learning. For example, a word low in an appearance frequency in all financial reports but high in the appearance frequency in financial reports of a company is a word that is characteristic of the company and that is highly likely to be an issue. Therefore, a phrase including the word is designated as the issue. Furthermore, it is possible to statistically estimate a sentence that is highly likely to include an issue from a feature of the sentence by means of a sentence analyze technique or a grammar analysis technique. For example, if it is known that long sentences tend to include issues, an issue is easier to find by focusing on search of the long sentences.

Furthermore, the qualitative data extraction section 105 determines whether the issues are similar under the condition (such as the business category to which the organization belongs, the sales volume of the organization, or management issue selection result) input to the input section 15. Therefore, it is possible to extract an issue suited for a use and accurately select the potential need of the target organization. It is noted that the management issue selection result is a result of selecting a management issue on which the user desires to place a higher weight from among a plurality of management issues presented by the output section 18. By providing a user interface such as a radio button on the screen output from the output section 18, it is possible to cause the user to select one management issue from among the plurality of management issues. Needless to say, there is no need to limit management issues to one management issue. It is possible to narrow down a few management issues from many management issues and consider the few management issues in combination. In this case, it is possible to consider the management issues in a wider range. For example, combining a personnel issue of a labor shortage with a financial issue of business profits in transit makes it possible to propose commodities or a solution for robotization that can solve the labor shortage while suppressing pays.

Furthermore, the judgment support system 1 includes the issue/measures selection section 102 that selects another organization similar in an attribute to a target organization to be analyzed while referring to the company attribute integrated data 113, and that selects an issue and measures of the selected other organization from the issue/measures data 114. Therefore, it is possible to provide information appropriate for supporting the organization activities. It is possible, in particular, to grasp the potential need and the measures of the target organization without inputting an issue. Needless to say, it is possible to directly input a management issue to the input section 15. In this case, it is possible to quickly input a management issue obtained by the user that paid a visit to a customer or the like to the judgment support system 1, thereby making it possible to ensure efficient work. It is also possible to analyze a management issue that is not registered in the judgment support system 1. The judgment support system 1 can place a higher weight on the directly input management issue, recommend commodities corresponding to the management issue, search similar management issues, and break down the management issue. For example, by user's inputting a management issue of a weight reduction in light automobiles requested by a customer in an automobile industry to the input section 15, the judgment support system 1 can search commodities and technical information of the own company to be associated with “automobiles, weight reduction.” In addition, the user can grasp a strong technique of the own company, that is, an aluminum processing technique and can take an order from the customer by proposing the technique to the customer.

Furthermore, the issue/measures selection section 102 changes a method of determining whether the attributes are similar on the basis of the condition (such as the business category to which each organization belongs or the sales volume of the organization) input to the input section 15. Therefore, it is possible to select an organization suited for a use and accurately select the potential need of the target organization.

Moreover, the judgment support system 1 includes the solution selection section 103 that selects commodities for executing the selected measures. Therefore, it is possible to recommend commodities suited for the measures of the customer to the customer.

Furthermore, the input section 15 receives input of a business category to which the target organization to be analyzed belongs or a target organization name, and the output section 18 outputs data for displaying an issue and measures of the target organization. Therefore, it is possible to grasp the potential need and the measures of the target organization without inputting an issue.

The present invention is not limited to the embodiment described above and encompasses various modifications and equivalent configurations within a scope of the spirit of the accompanying claims. For example, the abovementioned embodiment has been described in detail for describing the present invention so that the present invention is easy to understand. The present invention is not always limited to the embodiment having all the described configurations. Furthermore, a part of the configurations of a certain embodiment may be replaced by configurations of another embodiment. Moreover, the configurations of another embodiment may be added to the configurations of the certain embodiment. Furthermore, for a part of the configurations of each embodiment, addition, deletion, or replacement may be made for the other configurations.

Moreover, apart of or all of each of the configurations, the functions, the processing sections, processing means, and the like described above may be realized by hardware by being designed, for example, as an integrated circuit, or may be realized by software by causing a processor to interpret and execute programs that realize the functions.

Information on the programs, tables, files, and the like for realizing the functions maybe stored in a recording device such as a memory, a hard disk or an SSD (Solid State Drive), or in a recording medium such as an IC card, an SD card or a DVD.

Furthermore, control lines or information lines considered to be necessary for the description are illustrated and all the control lines or the information lines necessary for implementation are not always illustrated. In actuality, it may be contemplated that almost all the configurations are mutually connected.

What is claimed is:

1. A judgment support system for supporting a user's judgment, comprising:
a processor that executes a program;
a storage section that can be accessed by the processor; and
an output section that outputs data for displaying an execution result of the program, wherein
the judgment support system further comprises:
an extraction section that searches a predetermined sentence expression from data stored in the storage section, and that extracts an issue of an organization using text having a predetermined relationship with the searched sentence expression; and
a first selection section that selects a second organization confronted with an issue similar to an issue of a first organization to be analyzed, and that selects measures against the issue of the second organization from the data stored in the storage section, and
the output section outputs data for displaying the selected issue and the selected measures.

2. The judgment support system according to claim 1, wherein
the predetermined sentence expression is a phrase that enables a grammar to be analyzed with the sentence expression as a key, and
the extraction section extracts a word at a position having the predetermined relationship with the searched sentence expression as the issue.

3. The judgment support system according to claim 1, wherein
the predetermined sentence expression is a phrase that represents an issue determined using supervisory data, and
the extraction section extracts the searched sentence expression as text having the predetermined relationship and designates the text as the issue.

4. The judgment support system according to claim 1, further comprising:
an input section that receives input of a condition for determining whether issues are similar, wherein
the first selection section determines whether the issues are similar under the input condition.

5. The judgment support system according to claim 4, wherein
the condition input to the input section is any one of a business category to which the organization belongs, a sales volume of the organization, and an issue selection result.

6. The judgment support system according to claim 1, wherein
the issue of the organization is created on basis of numerical data of performance data or financial data.

7. A judgment support system for supporting a user's judgment, comprising:
a processor that executes a program;
a storage section that can be accessed by the processor; and
an output section that outputs data for displaying an execution result of the program, wherein
the judgment support system further comprises:
a second selection section that selects a second organization similar in an attribute to a first organization to be analyzed while referring to data representing attributes of the organizations and stored in the storage section, and that selects an issue and measures of the selected second organization from the data stored in the storage section, and
the output section outputs data for displaying the selected issue and the selected measures.

8. The judgment support system according to claim 7, comprising:
an input section that receives input of a condition for determining whether the attributes are similar, wherein
the second selection section changes a method of determining whether the attributes are similar on basis of the input condition.

9. The judgment support system according to claim 8, wherein
the condition input to the input section is any one of a business category to which each of the organizations belongs and a sales volume of each organization.

10. The judgment support system according to claim 1, wherein
the storage section stores data on commodities corresponding to the measures,
the judgment support system further comprises a commodity selection section that selects commodities for executing the selected measures, and
the output section outputs data for displaying the selected commodities.

11. The judgment support system according to claim 7, wherein
the storage section stores data on commodities corresponding to the measures,
the judgment support system further comprises a commodity selection section that selects commodities for executing the selected measures, and
the output section outputs data for displaying the selected commodities.

12. The judgment support system according to claim 1, further comprising:
an input section that receives input of a business category to which the first organization to be analyzed belongs or information specifying the first organization, wherein
the output section outputs data for displaying an issue and measures of the first organization.

13. The judgment support system according to claim 7, further comprising:
an input section that receives input of a business category to which the first organization to be analyzed belongs or information specifying the first organization, wherein
the output section outputs data for displaying an issue and measures of the first organization.

14. A judgment support method executed by a computer for supporting a user's judgment,
the computer including a processor that executes a program; a storage section that can be accessed by the processor; and an output section that outputs data for displaying an execution result of the program,
the method comprising:
searching, by the processor, a predetermined sentence expression from data stored in the storage section and extracting an issue of an organization using text having a predetermined relationship with the searched sentence expression;
selecting, by the processor, a second organization confronted with a similar issue to an issue of a first organization to be analyzed;
selecting, by the processor, measures against the issue of the second organization from the data stored in the storage section; and
outputting, by the output section, data for displaying the selected issue and the selected measures.

15. A judgment support method executed by a computer for supporting a user's judgment,
the computer including a processor that executes a program; a storage section that can be accessed by the processor; and an output section that outputs data for displaying an execution result of the program,
the method comprising:
selecting, by the processor, a second organization similar in an attribute to a first organization to be analyzed while referring to data representing attributes of the organizations and stored in the storage section;
selecting, by the processor, an issue and measures of the selected second organization from the data stored in the storage section; and
outputting, by the output section, data for displaying the selected issue and the selected measures.
